(19) United States
(12) Patent Application Publication
(10) Pub. No.: US 2025/0007040 A1
(43) Pub. Date: Jan. 2, 2025

(54) ENERGY STORAGE BATTERY CONTAINER SYSTEM AND METHOD FOR CONTROLLING ENERGY STORAGE BATTERY CONTAINER SYSTEM

(71) Applicant: Shenzhen CLOU Electronics CO., LTD, Shenzhen (CN)

(72) Inventor: Dongfang LI, Shenzhen (CN)

(73) Assignee: Shenzhen CLOU Electronics CO., LTD, Shenzhen (CN)

(21) Appl. No.: 18/637,852

(22) Filed: Apr. 17, 2024

(30) Foreign Application Priority Data
Jun. 30, 2023 (CN) 202310799665.2

(51) Int. Cl. H01M 10/6568; H01M 10/613; H01M 10/627; H01M 10/6551; H01M 10/6554; H01M 10/6556; H01M 10/6563; H01M 10/667

(52) U.S. Cl. CPC H01M 10/6568; H01M 10/613; H01M 10/6551; H01M 10/6554; H01M 10/6556; H01M 10/6563; H01M 10/627; H01M 10/667

(57) ABSTRACT

An energy storage battery container system and a method for controlling an energy storage battery container system are disclosed. The system includes a refrigeration assembly and a battery cluster unit. A refrigeration member is communicated with a first pipeline and can input coolant into the first pipeline. A first cooling plate and a second cooling plate are hollow. The first cooling plate can abut against a battery. The second cooling plate can abut against a heat generation component. One end of a second pipeline and one end of a third pipeline are both communicated with the first pipeline. The first cooling plate is communicated with the second pipeline and the third pipeline. Two ends of a fourth pipeline are both communicated with the third pipeline, and the second cooling plate is communicated with the fourth pipeline.

### CROSS-REFERENCE TO RELATED APPLICATION

This U.S. application claims priority to Chinese patent application No. 202310799665.2 filed on Jun. 30, 2023, the entire contents of which are incorporated herein by reference.

### TECHNICAL FIELD

The present disclosure relates to the technical field of electric energy storage systems, and in particular, to an energy storage battery container system and a method for controlling an energy storage battery container system.

### BACKGROUND

At present, the water-cooled unit within an energy storage container system can be coupled with liquid cooling pipes to convey coolant to the liquid cooling pipes, whereas the liquid cooling pipes are typically designed for cooling the battery modules within the energy storage container system only. However, there are also a large number of other heat generation boxes within the energy storage container, such as a control box, a DCDC module and a power distribution cabinet, which exhibit a relatively large heat generation power density. Currently, these heat generation boxes typically dissipate heat by using independent air-cooling systems or by configuring additional air-cooling air conditioners. This not only increases the auxiliary power consumption of the energy storage container system, but also reduces the utilization of the space occupied by the energy storage container system.

### SUMMARY

The present disclosure aims to at least solve one of the technical problems in the existing technology. Therefore, the present disclosure provides an energy storage battery container system, which can reduce the auxiliary power consumption and improve the utilization of the space occupied by the energy storage battery container system.

The present disclosure further provides a method for controlling an energy storage battery container system, which is applied to the energy storage battery container system.

An energy storage battery container system according to an embodiment in a first aspect of the present disclosure comprises: a refrigeration assembly comprising a refrigeration member and a first pipeline, wherein the refrigeration member is communicated with the first pipeline and is able to input coolant into the first pipeline; a battery cluster unit comprising a second valve, a sixth pipeline, a first cooling plate, a second cooling plate, a second pipeline, a third pipeline and a fourth pipeline, wherein the first cooling plate and the second cooling plate are hollow, the first cooling plate is able to abut against a battery, the second cooling plate is able to abut against a heat generation component, one end of the second pipeline and one end of the third pipeline are both communicated with the first pipeline, the first cooling plate is communicated with the second pipeline and the third pipeline, two ends of the fourth pipeline are communicated with the third pipeline, the second cooling plate is communicated with the fourth pipeline, two ends of the sixth pipeline are respectively communicated with the third pipeline and the first cooling plate, and the second valve is arranged on the sixth pipeline.

The energy storage battery container system according to the present disclosure has at least the following beneficial effects. In the embodiment of the present disclosure, the refrigeration member can convey coolant into the first pipeline, the first pipeline is communicated with the second pipeline and the third pipeline, the first cooling plate is hollow, and the first cooling plate is communicated with the second pipeline and the third pipeline, so that the coolant in the first pipeline can enter the first cooling plate from the second pipeline. The first cooling plate is able to abut against the battery, so that the first cooling plate can perform cooling operation on the battery through the coolant. The coolant in the first cooling plate can flow out from the third pipeline, the fourth pipeline is communicated with the third pipeline, and the second cooling plate is hollow, so that the coolant in the third pipeline can enter the fourth pipeline and flow into the second cooling plate. The second cooling plate is able to abut against the heat generation component, so that the second cooling plate can perform cooling operation on the heat generation component through the coolant, the coolant in the second cooling plate can flow back into the third pipeline, and the coolant in the third pipeline can flow back into the first pipeline. The refrigeration assembly of the energy storage battery container system can provide coolant for the first cooling plate and the second cooling plate through the first pipeline, the second pipeline, the third pipeline and the fourth pipeline, and can perform cooling operation on the battery and the heat generation component through the first cooling plate and the second cooling plate. Compared with the conventional energy storage container system, this energy storage battery container system can replace an air-cooling system in the conventional energy storage container system by the refrigeration assembly, the refrigeration assembly can simultaneously perform cooling operation on the battery and heat generation component, reduce auxiliary power consumption, and improve the utilization of the space occupied by the energy storage battery container system. Whether the coolant in the first cooling plate can enter the third pipeline from the sixth pipeline can be controlled by adjusting opening/closing of the second valve, wherein the coolant can remain in the first cooling plate by closing the second valve, so as to ensure the cooling effect of the first cooling plate.

According to some embodiments of the present disclosure, the battery cluster unit further comprises a first valve, wherein the first valve is arranged on the third pipeline and is positioned between portions where the third pipeline is communicated with two ends of the fourth pipeline.

According to some embodiments of the present disclosure, the battery cluster unit further comprises a plurality of fifth pipelines, and the sixth pipeline and the first cooling plate are both provided in plural, two ends of each of the fifth pipelines are respectively communicated with the second pipeline and a respective one of the first cooling plates, and two ends of each of the sixth pipelines are respectively communicated with the third pipeline and a respective one of the first cooling plates; and the second valve is provided in plural, each of the second valves is arranged on a respective one of the sixth pipelines.

According to some embodiments of the present disclosure, one end of the second pipeline far away from the first pipeline is provided with an exhaust valve.

According to some embodiments of the present disclosure, the first pipeline is provided in plural, and the second pipeline, the third pipeline and the fourth pipeline are provided in plural correspondingly.

According to some embodiments of the present disclosure, the energy storage battery container system further comprises a first compartment, the battery cluster unit is provided in plural, and all of the battery cluster units are arranged in the first compartment.

According to some embodiments of the present disclosure, the energy storage battery container system further comprises an electrical compartment unit, wherein the electrical compartment unit comprises a fan coil unit, a seventh pipeline and an eighth pipeline; and two ends of the seventh pipeline are respectively communicated with the first pipeline and the fan coil unit, and two ends of the eighth pipeline are respectively communicated with the first pipeline and the fan coil unit.

According to some embodiments of the present disclosure, the refrigeration assembly further comprises a third valve, wherein the third valve is arranged on the first pipeline and is positioned between portions where the first pipeline is communicated with one end of the seventh pipeline and one end of the eighth pipeline.

A method for controlling an energy storage battery container system is provided according to an embodiment in a second aspect of the present disclosure, which is applied to the energy storage battery container system according to the embodiment in the first aspect, and comprises:
continuously inputting coolant into the first pipeline, so that the coolant in the first pipeline enters the first cooling plate from the second pipeline;
placing a battery on the first cooling plate;
sensing a temperature of the battery; and
when the temperature of the battery is greater than a first preset temperature, opening a second valve, so that the coolant in the first cooling plate enters the third pipeline from the sixth pipeline.

The method for controlling an energy storage battery container system according to the embodiment of the second aspect of the present disclosure can at least achieve the following beneficial effects. The coolant is continuously input into the first pipeline, and the coolant is continuously pushed to move, so that the coolant in the first pipeline can enter the second pipeline and enter the first cooling plate. The battery is placed on the first cooling plate, and the coolant in the first cooling plate exchanges heat with the battery through the first cooling plate to perform cooling operation on the battery on the first cooling plate. The temperature of the battery is sensed and compared with a first preset temperature, when the temperature of the battery is greater than or equal to the first preset temperature, the second valve is opened, so that the coolant in the first cooling plate can flow out and enter the third pipeline from the sixth pipeline and then flow back into the first pipeline from the third pipeline. In this way, the coolant in the first pipeline can enter the first cooling plate, the coolant in the first cooling plate can be replaced, and the temperature of the battery can be dynamically adjusted, thereby ensuring the effect of the first cooling plate cooling the battery.

According to some embodiments of the present disclosure, the method for controlling an energy storage battery container system further comprises: continuously inputting coolant into the first pipeline, so that the coolant in the first pipeline continuously enters the fan coil unit from the seventh pipeline and flows back into the first pipeline from the eighth pipeline; continuously blowing cold air into the electrical compartment unit through the fan coil unit; sensing the temperature of the heat generation component in the electrical compartment unit; and when the temperature of the heat generation component is greater than a second preset temperature, closing the third valve to increase a flow quantity of the coolant in the first pipeline entering the seventh pipeline.

Additional aspects and advantages of the present disclosure will be set forth in part in the following description, some of which will be apparent from the following description, or will be learned by practice of the present disclosure.

### BRIEF DESCRIPTION OF DRAWINGS

The above or additional aspects and advantages of the present disclosure will become apparent and readily appreciated from the following description of the embodiments with reference to the accompanying drawings. In the drawings:

FIG. 1 is a schematic structural diagram of an energy storage battery container system according to the present disclosure;

FIG. 2 is a schematic structural diagram of a battery cluster unit of the energy storage battery container system according to the present disclosure;

FIG. 3 is a schematic structural diagram of a first cooling plate of the energy storage battery container system according to the present disclosure;

FIG. 4 is a schematic structural diagram of the first cooling plate and a battery of the energy storage battery container system according to the present disclosure; and

FIG. 5 is a schematic structural diagram of an electrical compartment unit of the energy storage battery container system according to the present disclosure.

### REFERENCE NUMERALS

10: battery; 100: refrigeration assembly; 110: first pipeline; 120: refrigeration member; 130: third valve; 200: battery cluster unit; 210: first cooling plate; 211: plug-in structure; 220: second pipeline; 221: exhaust valve; 230: third pipeline; 240: fourth pipeline; 250: fifth pipeline; 260: sixth pipeline; 270: second cooling plate; 280: first valve; 290: second valve; 300: electrical compartment unit; 310: seventh pipeline; 320: eighth pipeline; 330: fan coil unit; 340: power supply module; and 350: power distribution cabinet.

### DETAILED DESCRIPTION

Embodiments of the present disclosure will be described in detail below, and examples of the embodiments are shown in the accompanying drawings, wherein the same or similar reference numerals indicate the same or similar elements or elements having the same or similar functions throughout. The embodiments described below with reference to the accompanying drawings are illustrative only for the purpose of explaining the present disclosure, and are not to be construed as limiting the present disclosure.

In the description of the present disclosure, it should be understood that the directions or positional relationships indicated by terms such as “up”, “down”, “left”, “right”, “front”, “rear” and the like are those shown based on the accompanying drawings, and are merely intended to facilitate and simplify the description of the present disclosure rather than indicate or imply that the indicated apparatus or element must have a specific direction and must be configured and operated according to the specific direction. Therefore, these directions or positional relationships should not be construed as limiting the present disclosure.

In the description of the present disclosure, the description of “first” and “second” is merely for the purpose of distinguishing technical features, but shall not be understood as an indication or implication of relative importance, or an implicit indication of a quantity of indicated technical features, or an implicit indication of the sequence of the indicated technical features.

In the description of the present disclosure, unless otherwise explicitly defined, terms such as “arrange”, “mount”, “connect” and the like should be understood in a broad sense, and those of ordinary skills in the art can reasonably determine the specific meanings of the above terms in the present disclosure in conjunction with the specific contents of the technical solutions.

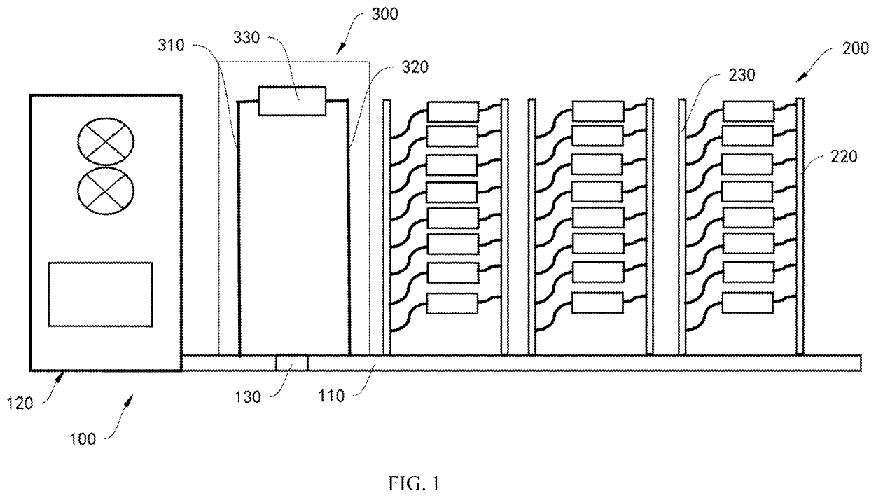

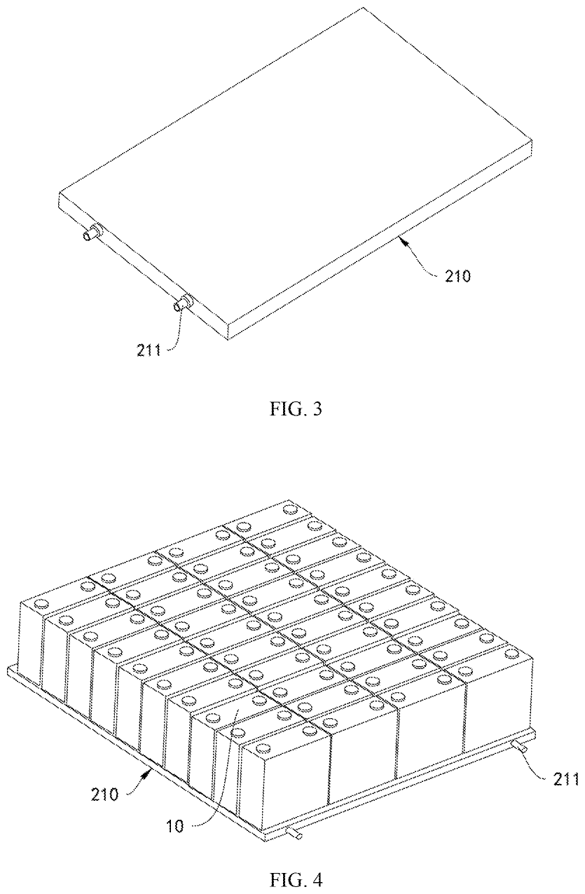

An energy storage battery container system and a method for controlling an energy storage battery container system according to the embodiments of the present disclosure are described below with reference to FIGS. 1 to 5.

The energy storage battery container system according to an embodiment in the first aspect of the present disclosure comprises a refrigeration assembly 100 and a battery cluster unit. The refrigeration assembly 100 comprises a refrigeration member 120 and a first pipeline 110, the refrigeration member 120 is communicated with the first pipeline 110 and can input coolant into the first pipeline 110. The battery cluster unit comprises a second valve 290, a sixth pipeline 260, a first cooling plate 210, a second cooling plate 270, a second pipeline 220, a third pipeline 230 and a fourth pipeline 240. The first cooling plate 210 and the second cooling plate 270 are hollow, the first cooling plate 210 can abut against a battery 10, the second cooling plate 270 can abut against a heat generation component. One end of the second pipeline 220 and one end of the third pipeline 230 are both communicated with the first pipeline 110. The first cooling plate 210 is communicated with the second pipeline 220 and the third pipeline 230, two ends of the fourth pipeline 240 are communicated with the third pipeline 230. The second cooling plate 270 is communicated with the fourth pipeline 240, two ends of the sixth pipeline 260 are respectively communicated with the third pipeline 230 and the first cooling plate 210, and the second valve 290 is arranged on the sixth pipeline 260.

In the embodiment of the present disclosure, the refrigeration member 120 can convey coolant into the first pipeline 110, the first pipeline 110 is communicated with the second pipeline 220 and the third pipeline 230, the first cooling plate 210 is hollow, and the first cooling plate 210 is communicated with the second pipeline 220 and the third pipeline 230, so that the coolant in the first pipeline 110 can enter the first cooling plate 210 from the second pipeline 220. The first cooling plate 210 can abut against the battery 10, so that the first cooling plate 210 can perform cooling operation on the battery 10 through the coolant. The coolant in the first cooling plate 210 can flow out from the third pipeline 230, the fourth pipeline 240 is communicated with the third pipeline 230, and the second cooling plate 270 is hollow, so that the coolant in the third pipeline 230 can enter the fourth pipeline 240 and flow into the second cooling plate 270. The second cooling plate 270 can abut against the heat generation component, so that the second cooling plate 270 can perform cooling operation on the heat generation component through the coolant, the coolant in the second cooling plate 270 can flow back into the third pipeline 230, and the coolant in the third pipeline 230 can flow back into the first pipeline 110. The refrigeration assembly 100 of the energy storage battery container system can provide coolant for the first cooling plate 210 and the second cooling plate 270 through the first pipeline 110, the second pipeline 220, the third pipeline 230 and the fourth pipeline 240, and can perform cooling operation on the battery 10 and the heat generation component through the first cooling plate 210 and the second cooling plate 270. Compared with the conventional energy storage container system, this energy storage battery container system can replace an air-cooling system in the conventional energy storage container system by the refrigeration assembly 100, the refrigeration assembly 100 can simultaneously perform cooling operation on the battery 10 and heat generation component, reduce auxiliary power consumption, and improve the utilization of the space occupied by the energy storage battery container system. Whether the coolant in the first cooling plate 210 can enter the third pipeline 230 from the sixth pipeline 260 can be controlled by adjusting opening/closing of the second valve 290, wherein the coolant can remain in the first cooling plate 210 by closing the second valve 290, so as to ensure the cooling effect of the first cooling plate 210.

Specifically, the refrigeration member 120 may be an air-cooled unit, a water-cooled unit or other cooling devices that can cool liquids. The refrigeration member 120 can perform cooling operation on the coolant, convey the coolant into the first pipeline 110, and receive the returned coolant from the first pipeline 110. The coolant may be a mixed liquid of ethylene glycol and water, wherein a volume ratio of the ethylene glycol to the water is 1:1, so that the anti-freezing effect can be effectively achieved in a low-temperature environment.

Specifically, the battery cluster unit comprises a switch control box, an internal resistance adjuster, and a plurality of batteries 10 connected to the first cooling plate 210. Two second cooling plates 270 are provided, and the switch control box and the internal resistance adjuster are respectively arranged on the two second cooling plates 270. Of course, the battery cluster unit may further comprise a DCDC (DC to DC converter) module, which may also be placed on the first cooling plate 210 to be cooled through the first cooling plate 210. Referring to FIG. 4, a plurality of batteries 10 can be placed on the same first cooling plate 210. The plurality of batteries 10 are connected in parallel or in series to form a battery cluster. The switch control box mainly controls the on-off state of the entire battery cluster, and the internal resistance adjuster mainly adjusts the internal resistance between the parallel battery clusters to reduce the circulating current generated during working among different battery clusters.

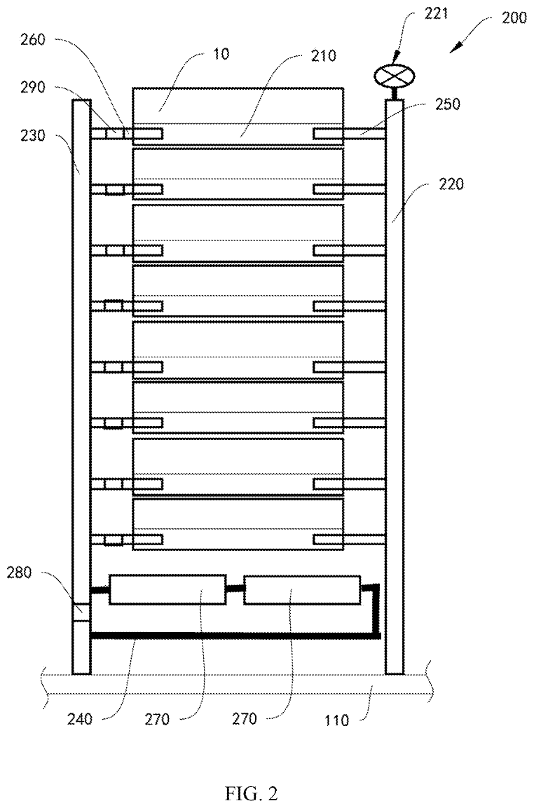

Referring to FIG. 2, it may be understood that the battery cluster unit further comprises a first valve 280, wherein the first valve 280 is arranged on the third pipeline 230 and is positioned between portions where the third pipeline 230 is communicated with two ends of the fourth pipeline 240.

Two ends of the fourth pipeline 240 are communicated with the third pipeline 230, so that the fourth pipeline 240 and a portion of the third pipeline 230 are arranged in parallel, and the coolant in the third pipeline 230 enters the fourth pipeline 240. The first valve 280 is provided between portions where the third pipeline 230 is communicated with two ends of the fourth pipeline 240, that is, the first valve 280 is provided at a portion where the third pipeline 230 is connected in parallel with the fourth pipeline 240, so that a flow quantity of the coolant entering the fourth pipeline 240 from the third pipeline 230 can be controlled by adjusting opening/closing of the first valve 280, and the efficiency of the second cooling plate 270 in cooling the first heat generation component can be further controlled. The coolant in the third pipeline 230 can all enter the fourth pipeline 240 by closing the first valve 280. Specifically, the first valve 280 may be an electromagnetic valve with an adjustable opening ratio, so as to dynamically adjust the flow quantity of the coolant entering the fourth pipeline 240 from the third pipeline 230, and thus dynamically adjust the efficiency of the second cooling plate 270 in cooling the first heat generation component, thereby meeting the heat dissipation requirement for cooling the first heat generation component.

Referring to FIG. 2, it may be understood that the battery cluster unit further comprises a plurality of fifth pipeline 250 and a plurality of sixth pipeline 260, and a plurality of first cooling plates 210 are provided. Two ends of each of the fifth pipelines 250 are respectively communicated with the second pipeline 220 and a respective one of the first cooling plates 210, and two ends of the sixth pipeline 260 are respectively communicated with the third pipeline 230 and a respective one of the first cooling plates 210.

The number of the batteries 10 that can be cooled is increased by providing the plurality of first cooling plates 210. One end of each of the fifth pipelines 250 is communicated with a side portion of the second pipeline 220, the other end of each of the fifth pipelines 250 is communicated with one end of a respective one of the first cooling plates 210, one end of each of the sixth pipelines 260 is communicated with a side portion of the third pipeline 230, and the other end of each of the sixth pipelines 260 is communicated with the other end of the respective one of the first cooling plates 210, so that the coolant in the second pipeline 220 can flow into the first cooling plate 210 from the fifth pipeline 250 and then flow into the third pipeline 230 from the sixth pipeline 260. The fifth pipeline 250 and the sixth pipeline 260 are respectively arranged at two ends of the first cooling plate 210, so as to increase a path through which the coolant can flow, and ensure the efficiency of the first cooling plate 210 in cooling the battery 10.

A length direction of the third pipeline 230 and the second pipeline 220 is a vertical direction, a plurality of first cooling plates 210 are provided and sequentially arranged in the vertical direction, one of the fifth pipelines 250 and one of the sixth pipelines 260 are both connected to a respective one of the first cooling plates 210, so that the first cooling plates 210 can be communicated with the second pipeline 220 and the third pipeline 230 through the respective fifth pipelines 250 and the respective sixth pipelines 260, and the second pipeline 220 and the third pipeline 230 can simultaneously provide coolant for the plurality of first cooling plates 210. The fifth pipelines 250 and the second pipeline 220 are integrally formed, and the sixth pipelines 260 and the third pipeline are integrally formed, reducing the mounting difficulty.

Specifically, referring to FIG. 4, plug-in structures 211 are provided at two sides of the first cooling plate 210, the plug-in structures 211 is provided with an inlet and an outlet, the inlet and the outlet are communicated with the inside of the first cooling plate 210, the fifth pipeline 250 and the sixth pipeline 260 can be respectively connected to the plug-in structures 211 on the first cooling plate 210 so as to be communicated with the inlet and the outlet. The difficulty in communicating the first cooling plate 210 with the fifth pipeline 250 and the sixth pipeline 260 can be reduced by providing the plug-in structures 211.

Referring to FIG. 2, it may be understood that the battery cluster unit further comprises a plurality of second valves 290, each of which is arranged on a respective one of the sixth pipelines 260.

Whether the coolant in the first cooling plate 210 can enter the third pipeline 230 from the sixth pipeline 260 can be controlled by adjusting opening/closing of the second valve 290, and the coolant can remain in the first cooling plate 210 by closing the second valve 290, so as to ensure the cooling effect of the first cooling plate 210. Specifically, the second valve 290 may be an electromagnetic valve with an adjustable opening ratio, so as to dynamically adjust the flow quantity of the coolant in the first cooling plate 210 entering the third pipeline 230 from the sixth pipeline 260, and thus dynamically adjust the efficiency of the first cooling plate 210 in cooling the battery 10, thereby meeting the heat dissipation requirement for cooling the battery 10.

Specifically, the second valve 290 may be connected to a BMS (Battery Management System) system online. The BMS system can be electrically connected to the battery 10 on the first cooling plate 210, and can detect the temperature of the battery 10. The second valve 290 can perform dynamical adjustment according to the average temperature of the battery 10 to ensure the consistency of the average temperature of each battery 10 in the battery cluster.

Referring to FIG. 2, it may be understood that one end of the second pipeline 220 far away from the first pipeline 110 is provided with an exhaust valve 221.

The gas in the second pipeline 220 can be discharged by arranging the exhaust valve 221, so that the gas entering the first cooling plate 210 from the second pipeline 220 can be reduced, and the first cooling plate 210 can be filled with coolant, ensuring the cooling effect of the first cooling plate 210.

Specifically, a length direction of the second pipeline 220 is a vertical direction, and the exhaust valve 221 is arranged at a top end of the second pipeline 220, so that the efficiency of discharging gas through the exhaust valve 221 can be improved.

Referring to FIG. 2, it may be understood that a plurality of first pipelines 110 are provided, and a plurality of second pipelines 220, third pipelines 230 and fourth pipelines 240 are provided correspondingly.

The refrigeration member 120 can output the coolant into the plurality of first pipelines 110 to improve efficiency of the refrigeration member 120 in outputting the coolant. One of the second pipelines 220 and one of the third pipelines 230 are both communicated with a respective one of the first pipelines 110, and the first cooling plate 210 is communicated with the plurality of second pipelines 220 and third pipelines 230, so as to improve the efficiency of the coolant entering and flowing out of the first cooling plate 210, and ensure the efficiency of the first cooling plate 210 in cooling the battery 10. In addition, the second cooling plate 270 is communicated with the plurality of fourth pipelines 240, so as to improve the efficiency of the coolant entering and flowing out of the second cooling plate 270, and ensure the efficiency of the second cooling plate 270 in cooling the first heat generation component.

Specifically, two first pipelines 110 are provided, and two second pipelines 220, two third pipelines 230 and two fourth pipelines 240 are provided. The refrigeration member 120 is provided with a liquid outlet and a liquid inlet, and two ends of the first pipeline 110 are respectively communicated with the liquid outlet and the liquid inlet of the refrigeration member 120, so that the refrigeration member 120 can input the coolant into the first pipeline 110 from the liquid outlet, and the coolant in the first pipeline 110 can flow out into the refrigeration member 120 from the liquid inlet, so as to enable the coolant to flow back into the refrigeration member 120. The refrigeration member 120 can refrigerate the coolant and re-output the coolant into the first pipeline 110 from the liquid outlet, so as to ensure the cooling effect of the first cooling plate 210 and the second cooling plate 270.

It may be understood that the energy storage battery container system further comprises a first compartment, and a plurality of battery cluster units are provided and all arranged in the first compartment.

The first compartment can protect a plurality of battery cluster units, prevent heat generated by the battery cluster units from being transferred to the outside of the first compartment during operation, and facilitate centralized management of the plurality of battery cluster units.

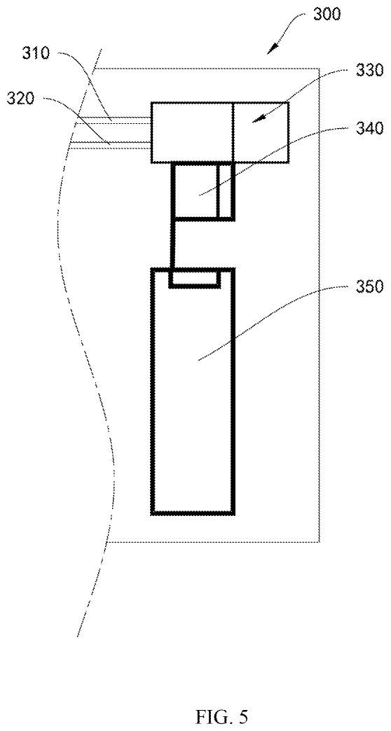

Referring to FIGS. 1 and 5, it may be understood that the energy storage battery container system further comprises an electrical compartment unit 300, wherein the electrical compartment unit 300 comprises a fan coil unit 330, a seventh pipeline 310 and an eighth pipeline 320. Two ends of the seventh pipeline 310 are respectively communicated with the first pipeline 110 and the fan coil unit 330, and two ends of the eighth pipeline 320 are respectively communicated with the first pipeline 110 and the fan coil unit 330.

The refrigeration member 120 can convey the coolant into the first pipeline 110, and the first pipeline 110 is communicated with the seventh pipeline 310 and the eighth pipeline 320, so that the coolant in the first pipeline 110 can enter the fan coil unit 330 from the seventh pipeline 310, the fan coil unit 330 can exchange heat with the coolant, and the fan coil unit 330 can blow out cold air with a certain flow rate to perform heat dissipation operation on other components of the electrical compartment unit 300. The coolant in the fan coil unit 330 can flow out from the eighth pipeline 320, and the coolant in the eighth pipeline 320 can flow back into the first pipeline 110, so that the coolant can flow back into the refrigeration member 120 or flow into the second pipeline 220.

Specifically, the electrical compartment unit 300 comprises a device compartment and a plurality of second heat generation component, such as a power supply module 340 and a power distribution cabinet 350. The fan coil unit 330, the power supply module 340 and the power distribution cabinet 350 are all positioned in the device compartment, the cold air blown out by the fan coil unit 330 and having a certain flow rate can pass through the power supply module 340 and the power distribution cabinet 350, and the hot air blown out from the power supply module 340 and the power distribution cabinet 350 is sucked by the fan coil unit 330 again for heat exchange, so that a complete thermal cycle can be formed in the electrical compartment unit 300. The electrical compartment unit 300 can further comprise other second heat generation components that needs heat dissipation, and the cold air can also dissipate heat from the second heat generation component in the device compartment.

Referring to FIG. 1, it may be understood that the refrigeration assembly 100 further comprises a third valve 130, wherein the third valve 130 is arranged on the first pipeline 110 and is positioned between portions where the first pipeline 110 is communicated with one end of the seventh pipeline 310 and one end of the eighth pipeline 320.

One end of the seventh pipeline 310 is communicated with the first pipeline 110, and one end of the eighth pipeline 320 is communicated with the first pipeline 110, so that the seventh pipeline 310 and the eighth pipeline 320 are connected in parallel to a portion of the first pipeline 110, and the coolant in the first pipeline 110 enters the seventh pipeline 310. The third valve 130 is provided at a portion where the first pipeline 110 is communicated with one end of the seventh pipeline 310 and one end of the eighth pipeline 320, that is, the third valve 130 is provided at a portion where the first pipeline 110 is connected in parallel to the seventh pipeline 310 and the eighth pipeline 320, so that a flow quantity of the coolant entering the seventh pipeline 310 from the first pipeline 110 can be controlled by adjusting opening/closing of the third valve 130, and the efficiency of the cooling of the fan coil unit 330 can be controlled. Closing of the third valve 130 enables the coolant in the first pipeline 110 to all enter the seventh pipeline 310. Specifically, the third valve 130 may be an electromagnetic valve with an adjustable opening ratio, so as to dynamically adjust the flow quantity of the coolant entering the seventh pipeline 310 from the first pipeline 110, and thus dynamically adjust the efficiency of the cooling fan coil unit 330, thereby meeting the requirement of the cooling fan coil unit 330.

It may be understood that the energy storage battery container system further comprises a second compartment, and the refrigeration member 120 and the electrical compartment unit 300 are all arranged in the second compartment.

The second compartment can protect the refrigeration member 120 and the electrical compartment unit 300, prevent heat generated by the refrigeration member 120 and the electrical compartment from being transferred to the outside of the second compartment during operation, and facilitate centralized management of the refrigeration member 120 and the electrical compartment.

Referring to FIGS. 1 to 5, a method for controlling an energy storage battery container system according to an embodiment in a second aspect of the present disclosure is provided, which is applied to the energy storage battery container system according to the embodiment in the first aspect, comprising the following steps:
continuously inputting coolant into the first pipeline 110, so that the coolant in the first pipeline 110 enters the first cooling plate 210 from the second pipeline 220;
placing a battery 10 on the first cooling plate 210;
sensing a temperature of the battery 10; and
when the temperature of the battery 10 is greater than or equal to a first preset temperature, opening a second valve 290, so that the coolant in the first cooling plate 210 enters the third pipeline from the sixth pipeline 260.

The coolant is continuously input into the first pipeline 110, and the coolant is continuously pushed to move, so that the coolant in the first pipeline 110 can enter the second pipeline 220 and enter the first cooling plate 210. The battery 10 is placed on the first cooling plate 210, and the coolant in the first cooling plate 210 exchanges heat with the battery 10 through the first cooling plate 210 to perform cooling operation on the battery 10 on the first cooling plate 210. The temperature of the battery 10 is sensed, the temperature of the battery 10 is compared with a first preset temperature. When the temperature of the battery 10 is greater than or equal to the first preset temperature, the second valve 290 is opened, so that the coolant in the first cooling plate 210 can flow out and enter the third pipeline from the sixth pipeline 260 and then flow back into the first pipeline 110 from the third pipeline. In this way, the coolant in the first pipeline 110 can enter the first cooling plate 210, the coolant in the first cooling plate 210 can be replaced, and the temperature of the battery 10 can be dynamically adjusted, thereby ensuring the effect of the first cooling plate 210 cooling the battery 10.

Specifically, the second valve 290 is typically in a closed state to enable the coolant in the first cooling plate 210 to remain in the first cooling plate 210 and to enable the first cooling plate 210 to be filled with the coolant. When the temperature of the battery 10 is less than a first preset temperature, the second valve 290 is closed to further dynamically adjust the temperature of the battery 10 according to the magnitude of the temperature of the battery 10.

Specifically, the second valve 290 may be an electromagnetic valve with an adjustable opening ratio, so as to dynamically adjust the flow quantity of the coolant in the first cooling plate 210 entering the third pipeline 230 from the sixth pipeline 260, and thus dynamically adjust the efficiency of the first cooling plate 210 in cooling the battery 10, thereby meeting the heat dissipation requirement for cooling the battery 10.

It may be understood that the method for controlling an energy storage battery container system further comprises the following steps:
continuously inputting the coolant into the first pipeline 110, so that the coolant in the first pipeline 110 continuously enters the fan coil unit 330 from the seventh pipeline 310 and flows back into the first pipeline 110 from the eighth pipeline 320;
continuously blowing cold air into the electrical compartment unit through the fan coil unit 330;
sensing a temperature of a heat generation component in the electrical compartment unit 300; and
when the temperature of the heat generation component is greater than or equal to a second preset temperature, closing the third valve 130 to increase a flow quantity of the coolant in the first pipeline 110 entering the seventh pipeline 310.

The coolant is continuously input into the first pipeline 110, and the coolant is continuously pushed to move, so that the coolant in the first pipeline 110 can enter the seventh pipeline 310 and then enter the fan coil unit 330. The fan coil unit 330 can be cooled by the coolant, and cold air can be continuously blown into the electrical compartment unit through the fan coil unit 330 to perform cooling operation on the heat generation component in the electrical compartment unit 300. The temperature of the heat generation component is sensed, the temperature of the heat generation component is compared with the second preset temperature. When the temperature of the heat generation component is greater than or equal to the second preset temperature, the third valve 130 connected in parallel to the fan coil unit 330 is closed, so that the coolant in the first pipeline 110 can enter the seventh pipeline, to improve the flow quantity of the coolant passing through the fan coil unit 330. In this way, the temperature of the heat generation component can be dynamically adjusted, ensuring the effect of cooling the heat generation component by the fan coil unit 330.

Specifically, the third valve 130 is typically in an open state to reduce the flow quantity of the coolant passing through the fan coil unit 330. When the temperature of the heat generation component is less than a third preset temperature, the third valve 130 is opened to further dynamically adjust the temperature of the heat generation component according to the magnitude of the temperature of the heat generation component. The third preset temperature is less than the second preset temperature to further ensure the cooling effect of the fan coil unit 330.

Specifically, the third valve 130 may be an electromagnetic valve with an adjustable opening ratio, so as to dynamically adjust the flow quantity of the coolant entering the seventh pipeline 310 from the first pipeline 110, and thus dynamically adjust the efficiency of the cooling fan coil unit 330, thereby meeting the requirement of the cooling fan coil unit 330.

In the description of this specification, the description with reference to the terms “an embodiment”, “some embodiments”, “some examples” or the like means the particular features, structures, materials or characteristics described in combination with the embodiment or example are included in at least one embodiment or example of the present disclosure. In this specification, the schematic expression of the above terms does not necessarily refer to the same embodiments or examples. Furthermore, the specific features, structures, materials, or characteristics described can be combined in any suitable manner in any one or more embodiments or examples.

Although the embodiments of the present disclosure have been shown and described, it may be understood by those of ordinary skill in the art that various changes, modifications, substitutions, and alterations may be made to these embodiments without departing from the principle and purpose of the present disclosure, and the scope of the present disclosure is defined in the claims and equivalents thereof.

What is claimed is:

1. An energy storage battery container system, comprising:
a refrigeration assembly comprising a refrigeration member and a first pipeline, wherein the refrigeration member is communicated with the first pipeline and is able to input coolant into the first pipeline; and
a battery cluster unit comprising a second valve, a sixth pipeline, a first cooling plate, a second cooling plate, a second pipeline, a third pipeline and a fourth pipeline, wherein the first cooling plate and the second cooling plate are hollow, the first cooling plate is able to abut against a battery, the second cooling plate is able to abut against a heat generation component, one end of the second pipeline and one end of the third pipeline are both communicated with the first pipeline, the first cooling plate is communicated with the second pipeline and the third pipeline, two ends of the fourth pipeline are communicated with the third pipeline, the second cooling plate is communicated with the fourth pipeline, two ends of the sixth pipeline are respectively communicated with the third pipeline and the first cooling plate, and the second valve is arranged on the sixth pipeline.

2. The energy storage battery container system according to claim 1, wherein the battery cluster unit further comprises a first valve, and the first valve is arranged on the third pipeline and is positioned between portions where the third pipeline is communicated with two ends of the fourth pipeline.

3. The energy storage battery container system according to claim 1, wherein
the battery cluster unit further comprises a plurality of fifth pipelines, and the sixth pipeline and the first cooling plate are provided in plural, two ends of each of the fifth pipelines are respectively communicated with the second pipeline and a respective one of the first cooling plates, and two ends of each of the sixth pipelines are respectively communicated with the third pipeline and a respective one of the first cooling plates; and the second valve is provided in plural, each of the second valves is arranged on a respective one of the sixth pipelines.

4. The energy storage battery container system according to claim 1, wherein one end of the second pipeline far away from the first pipeline is provided with an exhaust valve.

5. The energy storage battery container system according to claim 1, wherein
the first pipeline is provided in plural, and the second pipeline, the third pipeline and the fourth pipeline are provided in plural correspondingly.

6. The energy storage battery container system according to claim 1, further comprising:
a first compartment, wherein the battery cluster unit is provided in plural, and all of the battery cluster units are arranged in the first compartment.

7. The energy storage battery container system according to claim 1, further comprising:
an electrical compartment unit, wherein the electrical compartment unit comprises a fan coil unit, a seventh pipeline and an eighth pipeline; and two ends of the seventh pipeline are respectively communicated with the first pipeline and the fan coil unit, and two ends of the eighth pipeline are respectively communicated with the first pipeline and the fan coil unit.

8. The energy storage battery container system according to claim 7, wherein
the refrigeration assembly further comprises a third valve, and the third valve is arranged on the first pipeline and is positioned between portions where the first pipeline is communicated with one end of the seventh pipeline and one end of the eighth pipeline.
